(19) United States
(12) Patent Application Publication
(10) Pub. No.: US 2021/0229066 A1
(43) Pub. Date: Jul. 29, 2021

(54) Solid Adsorbent Compositions for Purifying Liquids

(71) Applicants: Dennis N. Malaba, Uniontown, OH (US); George E. Hicks, Elizabeth, IN (US); Andrey Bagreev, Chesterfield, VA (US); James D. Stryker, Pittstown, NJ (US)

(72) Inventors: Dennis N. Malaba, Uniontown, OH (US); George E. Hicks, Elizabeth, IN (US); Andrey Bagreev, Chesterfield, VA (US); James D. Stryker, Pittstown, NJ (US)

(21) Appl. No.: 17/159,513

(22) Filed: Jan. 27, 2021

Related U.S. Application Data
(60) Provisional application No. 62/967,306, filed on Jan. 29, 2020.
(60) Provisional application No. 63/026,332, filed on May 18, 2020.
(60) Provisional application No. 63/082,079, filed on Sep. 23, 2020.

(51) Int. Cl. B01J 20/10; B01J 20/24; B01J 20/28; C10L 1/02; C11B 3/10; B01D 15/16; A23D 9/04

(52) U.S. Cl. CPC B01J 20/10; B01J 20/24; B01J 20/2803; C10L 1/026; C10L 2290/542; B01D 15/161; A23D 9/04; C10L 2200/0476; C11B 3/10

(57) ABSTRACT

A composition for purifying a liquid, such as used cooking oil, unrefined edible oils, or biodiesel fuel, that comprises at least one purifying material, such as magnesium silicate, and at least one binder material that is a solid or a semi-solid at room temperature, or is water or a glycol. When the composition is placed in a liquid, and the liquid is heated, the solid composition disintegrates and the at least one purifying material is released in the liquid. Such composition minimizes or eliminates contact with the dust associated with solid adsorbent materials, and provides for a controlled release of the at least one purifying material into the liquid to be purified.

This application claims priority based on Provisional Application Ser. No. 62/967,306, filed Jan. 29, 2020, Provisional Application Ser. No. 63/026,332, filed May 18, 2020, and Provisional Application Ser. No. 63/082,079, filed Sep. 23, 2020, the contents of which are incorporated by reference in their entireties.

This invention relates to solid compositions for purifying liquids such as used cooking oil, unrefined edible oils, biodiesel fuel, and dielectric fluids. More particularly, this invention relates to solid compositions that include at least one purifying material, such as an adsorbent, and at least one binder material. When such composition is placed in a liquid to be purified, and the liquid is heated, the solid composition disintegrates, and the at least one purifying material is released into the liquid, whereby the liquid is purified.

Purifying powders, such as adsorbents, have been used to remove impurities from liquids such as used cooking oils (See, for example, U.S. Pat. Nos. 4,681,768; 5,597,600; and 6,638,648.), unrefined edible oils (Sec U.S. Pat. No. 9,295,810.), and biodiesel fuel (See U.S. Pat. No. 7,635,398.) Although the purifying powders are effective in removing impurities from the above-mentioned liquids, such powders often contain dust, which may come in contact with the skin and/or nasal passages, whereupon the dust may be inhaled accidentally.

U.S. Pat. Nos. 6,312,598 and 6,482,326 disclose filter pads which are impregnated with magnesium silicate powder; however, such pads have dust on their surfaces.

It therefore is an object of the present invention to provide a means for delivering purifying powders, such as adsorbent magnesium silicate powder, to a liquid to be purified, whereby contact with the dust associated with such powders is minimized or eliminated. In addition, the means for delivering the purifying polymers should be easy to use, and provide a controlled release of the purifying powder.

In accordance with an aspect of the present invention, there is provided a composition for purifying a liquid. The composition comprises at least one purifying material and at least one binder material. The at least one binder material is selected from the group consisting of hydrogenated vegetable oils, saturated vegetable oils, animal fats, waxes, water, glycols, fatty acids, fatty alcohols, fatty acid esters, fatty alcohol esters, and mixtures thereof.

In a non-limiting embodiment, the at least one purifying material is selected from the group consisting of metal silicates, silica gel, amino-functionalized silicas, such as those disclosed in U.S. Published Patent Application No. 2019/03228011, activated carbon, alkali metal silicates, magnesium phosphate, metal hydroxides, metal oxides, metal carbonates, metal bicarbonates, alkaline earth metal hydroxides, alkaline earth metal oxides, sodium sesquicarbonate, bleaching clays, bleaching earths, bentonite clay, diatomaceous earth, alumina, diatomite, perlite, alkali materials including, but not limited to, metal hydroxides such as sodium hydroxide, potassium hydroxide, and calcium hydroxide, and mixtures thereof.

In another non-limiting embodiment, the at least one purifying material comprises at least one metal silicate. In another non-limiting embodiment, the at least one metal silicate is selected from the group consisting of magnesium silicate, magnesium aluminum silicate, calcium silicate, aluminum silicate, sodium silicate, and mixtures thereof. In yet another non-limiting embodiment, the at least one metal silicate comprises magnesium silicate.

In one non-limiting embodiment, the magnesium silicate has the following properties:

| | |
|---|---|
| % MgO | 15% min. (ignited basis |
| % SiO₂ | 67% min. (ignited basis) |
| Soluble salts | 3% max. |
| Mole ratio MgO:SiO₂ | 1:1.36 to 1:3.82 |

In another non-limiting embodiment, the magnesium silicate is an amorphous, hydrated, precipitated, synthetic magnesium silicate having a surface area of at least 100 square meters per gram. In another non-limiting embodiment, the magnesium silicate has a surface area from about 300 square meters per gram to about 800 square meters per gram. In yet another non-limiting embodiment, the magnesium silicate has a surface area from about 400 square meters per gram to about 600 square meters per gram. In addition, such magnesium silicate may be employed as coarse particles, with at least 75%, and preferably at least 85% of the particles having a particle size which is greater than 400 mesh, and with no more than 15%, and preferably no more than 5%, all by weight, having a particle size greater than 40 mesh. In most cases, the average particle size of the magnesium silicate employed in accordance with the present invention is in the order of but not limited to 20-175 microns. It is to be understood, however, that the magnesium silicate may have a particle size different than the sizes mentioned hereinabove.

In another non-limiting embodiment, the magnesium silicate which is employed in accordance with a non-limiting embodiment of the present invention generally has a bulk density in the order of from 15-35 lbs./cu. ft., a pH of 3-10.8 (5% water suspension) and a mole ratio of MgO to SiO₂ of 1:1.0 to 1:4.0.

The following is a specification and typical value for a magnesium silicate which is employed in accordance with a non-limiting embodiment of the present invention.

| Parameter | Specification | Typical Value |
|---|---|---|
| Mole Ratio MgO:SiO₂ | 1:1.0 to 1:4.0 | 1:2.60 |
| pH of 5% Water Suspension | 8.0 to 10.8 | 9.0 |
| Soluble Salts % & by wt. | 3.0 max. | 1.0% |
| Surface Area (B.E.T.) | 100 to 800 m²/g | 400 |

A representative example of such an amorphous, hydrated, precipitated synthetic magnesium silicate having a surface area of at least 300 square meters per gram is available as Magnesol® Polysorb 30/40, a product of the Dallas Group of America, Inc., Whitehouse, N.J., and also is described in U.S. Pat. No. 4,681,768.

In another non-limiting embodiment, the magnesium silicate is a magnesium silicate which has a surface area of no more than 150 square meters per gram. In another non-limiting embodiment, the magnesium silicate has a surface area from about 50 square meters per gram to about 150 square meters per gram. In a non-limiting embodiment, the magnesium silicate has a surface area such a magnesium silicate has a mole ratio of MgO to SiO₂ of from about 1:3.0 to about 1:3.8, and a pH (5% water suspension) of from about 9.5 to about 10.5. An example of such a magnesium silicate is available as Magnesol® HMR-LS, a product of the Dallas Group of America, Inc., Whitehouse. N.J.

In another non-limiting embodiment, the magnesium silicate is an amorphous, hydrous, precipitated synthetic magnesium silicate, which has a pH less than about 9.0. As used herein, the term “precipitated” means that the amorphous hydrated precipitated synthetic magnesium silicate is produced as a result of precipitation formed upon the contact of a magnesium salt and a source of silicate in an aqueous medium.

For purposes of the present invention, the pH of the magnesium silicate is the pH of the magnesium silicate as measured in a 5% slurry of the magnesium silicate in water. The pH of the magnesium silicate in a 5% slurry may be from about 8.2 to about 8.9, and more preferably from about 8.5 to about 8.8, and most preferably is about 8.5. Examples of such amorphous hydrous precipitated synthetic magnesium silicates are described in U.S. Pat. No. 5,006,356, and also are available as Magnesol® products such as Magnesol® R30, Magnesol®: R60, and D-SOM. D60, products of the Dallas Group of America. Inc., Whitehouse, N.J.

In a further non-limiting embodiment, the magnesium silicate has a pH (5% water suspension) of from about 9.0 to about 9.5. In another non-limiting embodiment, the magnesium silicate may be in the form of talc.

Representative examples of magnesium silicate which may be employed in accordance with the present invention also are described in U.S. Pat. Nos. 4,681,768; 5,006,356; 5,597,600; 6,312,598; 6,368,648; 6,482,386; 7,635,398; 9,295,810; and 10,563,150, the contents of which are incorporated herein by reference.

It is to be understood, however, that the scope of the present invention is not to be limited to any specific type of magnesium silicate or method for the production thereof: In general, the at least one binder material is a solid or semi-solid material at room temperature, or is a liquid selected from the group consisting of water, glycols, and mixtures thereof. In a non-limiting embodiment, the at least one binder material is selected from the group consisting of hydrogenated vegetable oils, saturated vegetable oils, high oleic acid oils, animal fats, waxes, water, glycols, butters, shortenings, artificial lipids, synthetic fats and fat substitutes, fatty acids, and mixtures thereof.

In a non-limiting embodiment that at least one binder material is at least one hydrogenated vegetable oil. In another non-limiting embodiment, the at least one hydrogenated vegetable oil is soybean oil.

In a non-limiting embodiment, the at least one binder material is at least one saturated vegetable oil. In another non-limiting embodiment, the at least one saturated vegetable oil is palm oil.

In another non-limiting embodiment, the at least one saturated vegetable oil is peanut oil.

In a non-limiting embodiment, the at least one binder material is at least one fatty acid.

In another non-limiting embodiment, the at least one fatty acid is a saturated fatty acid.

Saturated fatty acids that may be used include but are not limited to, capric acid (decanoic acid), undecylic acid (undecanoic acid), lauric acid (dodecanoic acid), tridcylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid), arachidic acid (eicosanoic acid), beneicosylic acid (heneicosanoic acid), behenic acid (docosanoic acid), tricosylic acid (tricosanoic acid), lignoceric acid (tetracosanoic acid), pentacosylic acid (pentacosanoic acid), cerotic acid (hexacosanoic acid), carboceric acid (hoptacosanoic acid), montanic acid (octacosanoic acid), nonacosylic acid (nonacosanoic acid), melissic acid (triacontanoic acid), hentriacontylic acid (hentriacontanoic acid), lacceroic acid (dotriacontanoic acid), psyllic acid (tritriacontanoic acid), geddie acid (tetratriacomtanoic acid), ceroplastic acid pentatriacontanoic acid), hexatriacontylic acid (hexatriacontanoic acid), heptatriacontylic acid (heptatriacontanoic acid), ctatriacontylic acid (octatriacontanoic acid), nonatriacxmtylic acid (nonatriacontanoic acid) and tetracontylic acid (tetracontanoic acid).

In another non-limited embodiment, the at least one fatty acid is an unsaturated fatty acid. Unsaturated fatty acids that may be used include, but are not limited to, α-Linolenic acid, stearidonic acid, eicosapentaenoic acid, cervonic acid, linoleic acid, linoelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, crucic acid, nervonic acid, mead acid.

In a non-limiting embodiment, the at least one fatty acid has at least 10 carbon atoms. In another non-limiting embodiment, the at least one fatty acid has at least 16 carbon atoms.

Fatty acids having at least 16 carbon atoms which may be used include, but are not limited to, linolenic acid, linoleic acid, stearic acid, oleic acid, and palmitic acid. In a non-limiting embodiment, the at least one fatty acid having at least 16 carbon atoms is stearic acid.

In another non-limiting embodiment, the at least one binder material is at least one fatty alcohol. In another non-limiting embodiment the at least one fatty alcohol has at least 12 carbon atoms, and may be a saturated or unsaturated fatty alcohol.

Fatty alcohols that may be used include, but are not limited to, lauryl alcohol (dodecanol, 1-dodecanol), tridecyl alcohol (1-tridecanol, tridecanol, isotridecanol), myristyl alcohol (1-tetradecanol), pentadecyl alcohol (1-pentadecanol, pentadecanol), cetyl alcohol (1-hexadecanol), palmitoleyl alcohol (cis-9-hexadecen-1-ol), heptadecyl alcohol (1-n-heptadecanol, heptadecanol), stearyl alcohol (1-octadecanol), nonadecyl alcohol (1-nonadecanol), arachidyl alcohol (1-eicosanol), heneicosyl alcohol (1-heneicosanol), behenyl alcohol (1-docosanol), erucyl alcohol (cis-3-docosen-1-ol), lignoceryl alcohol (1-tetracosanol), ceryl alcohol (1-hexacosanol), I-heptacosanol, montanyl alcohol, cluytyl alcohol, or 1-octacosanol, 1-nonacosanol, myricyl alcohol, melissyl alcohol, or 1-triacontanol, 1-dotriacontanol (lacceryl alcohol) and geddyl alcohol (I-tetratriacontanol) in a non-limiting embodiment, the at least one fatty alcohol is stearyl alcohol.

In another non-limiting embodiment, the at least one binder material is at least one fatty acid ester of a monohydroxy compound. In another non-limiting embodiment, the fatty acid has at least 10 carbon atoms, and may be a saturated or unsaturated fatty acid and wherein said monohydroxy compound has from 1 to 20 carbon atoms, and which may include straight, branched or cyclic groups and the straight, branched, or cyclic groups may be saturated or unsaturated.

Saturated fatty acids that may be used in fatty acid esters include, but are not limited to, capric acid (decanoic acid), undecylic acid (undecanoic acid), lauric acid (dodecanoic acid), tridecylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid), arachidic acid (eicosanoic acid), heneicosylic acid (heneicosanoic acid), behenic acid (docosanoic acid), tricosylic acid (tricosanoic acid), lignoceric acid (tetracosanoic acid), pentacosylic acid (pentacosanoic acid), cerotic acid (hexacosanoic acid), carboceric acid (heptacosanoic acid), montanic acid (octacosanoic acid), nonacosylic acid (nonacosanoic acid), melissic acid (triacontanoic acid), hentriacontylic acid hentriacontanoic acid), lacceroic acid (dotriacontanoic acid), psyllic acid (tritriacontanoic acid), geddie acid (tetratriacontanoic acid), ceroplastic acid (pentatriacontanoic acid), hexatriacontylic acid (hexatriacontanoic acid), heptatriacontylic acid (heptatriacontanoic acid), octatriacontylic acid (octatriacontanoic acid), nonatriacontylic acid (nonatriacontanoic acid) and tetracontylic acid (tetracontanoic acid)

Unsaturated fatty acids that may be used in fatty acid esters include α-linolenic acid, stearidonic acid, eicosapentaenoic acid, cervonic acid, linoleic acid, linoelaidic acid, γ-linolenic acid, dihomo-γ-linolenic acid, arachidonic acid, docosatetraenoic acid, palmitoleic acid, vaccenic acid, paullinic acid, oleic acid, elaidic acid, gondoic acid, erucic acid, nervonic acid, and mead acid.

In another non-limiting embodiment, the at least one fatty acid has at least 16 carbon atoms. In yet another non-limiting embodiment, the at least one fatty acid is selected from the group consisting of linolenic acid, linoleic acid, stearic acid, oleic acid and palmitic acid. In a non-limiting embodiment, the at least one fatty acid having at least 16 carbon atoms is stearic acid. Classes of monohydroxy compounds that may be used to make fatty acid esters of this non-limiting embodiment include, but are not limited to, alkyl alcohols, alkenyl alcohols, alkynyl alcohols, aralkyl alcohols, aryl alcohols, and alkyether alcohols.

Examples of alkyl alcohols include, but are not limited to, methyl alcohol, ethyl alcohol, propyl alcohol, isopropyl alcohol, cyclopropyl alcohol, cyclopropylmethyl alcohol, butyl alcohol, sec-butyl alcohol, tert-butyl alcohol, pentyl alcohol, neopentyl alcohol, amyl alcohol, hexyl alcohol, cyclohexyl alcohol, menthyl alcohol, heptyl alcohol, octyl alcohol, nonyl alcohol, decyl alcohol, undecyl alcohol, dodecyl alcohol, tridecyl alcohol, tetradecyl alcohol, pentadecyl alcohol, hexadecyl alcohol, heptadecyl alcohol, octadecyl alcohol, nonadecyl alcohol, and icosanyl alcohol. In a non-limiting embodiment, the at least one monohydroxy compound is ethyl alcohol.

Specific examples of alkenyl alcohols include, but are not limited to, vinyl alcohol, i-methylvinyl alcohol, 1-propenyl alcohol, 2-methyl-1-propenyl alcohol, I-butenyl alcohol, 3-methyl-2-butenyl alcohol, hexenyl alcohol, heptenyl alcohol, octenyl alcohol nonenyl alcohol, decenyl alcohols, and the like.

Specific examples of alkynyl alcohols include, but are not limited to, propargyl alcohol, butynyl alcohol, pentynyl alcohol, hexynyl alcohol, heptynyl alcohol, octynyl alcohol, nonynyl alcohol, decynyl alcohol, and the like.

Specific examples of aralkyl groups include, but are not limited to, aralkyl alcohols having 7 to 20 carbon atoms, such as benzyl alcohol, phenethyl alcohol, phenylpropyl alcohol, naphthylmethyl alcohol, anthracenylmethyl alcohol, and the like.

Specific examples of aryl alcohols that may be used include, but are not limited to, aryl alcohols having 6 to 20 carbon atoms, such as phenyl alcohol, 1-naphthyl alcohol, 2-naphthyl alcohol, and the like.

Specific examples of alkylether alcohols that may be used include, but are not limited to, alkylether alcohols having up to 8 carbon atoms, such as methoxymethanol, methoxyethanol, methoxypropanol, methoxybutanol, ethoxyethanol, propoxyethanol, isopropoxyethanol, butoxyethanol, sec-butoxyethanol, tert-butoxyethanol, and the like.

In another non-limiting embodiment, the at least one binder material is at least one fatty acid ester of a polyhydric alcohol wherein the fatty acid has at least 10 carbon atoms, and may be a saturated or unsaturated fatty acid, and wherein said polyhydric alcohol is a polyol having a linear, branched, or cyclic unit which has at least 2 carbon atoms and has at least 2 hydroxyl groups per molecule.

Specific examples of polyhydric alcohols with linear, branched, or cyclic alkylene units that may be used include, but are not limited to, those selected from the group consisting of 1,2-ethanediol, glycerol, 1,2-propanediol, 1,3-propanediol, 1,3-butanediol, 1,4-butanediol, neopentyl glycol, 2,2-dimethylolbutane, trimethylolethane, trimethylolpropane, trimethylolbutane, 2,2,4-trimethylpentane-1,3-diol, 1,2-hexanediol, 1,6-hexanediol, pentaerythritol, dipentaerythritol, tripentaerythritol, triethylene glycol, tetraethylene glycol, dipropylene glycol, tripropylene glycol, tetrapropylene glycol, and the like. In a non-limiting embodiment, the polyhydric alcohol is glycerol.

Other specific examples of polyhydric alcohols include, but are not limited to, sugar alcohols that include glucose, mannose, galactose, xylose, fructose, sorbose, tagatose, ribulose, xylulose, lactose, maltose, raffinose, cellobiose, sucrose, erythritol, mannitol, lactitol, sorbitol, xylitol, alpha-methylglucoside, maltitol, isomalt, and the like. In a non-limiting embodiment, the polyhydric alcohol is a sugar alcohol that includes sorbitol.

In a non-limiting embodiment, the at least one binder material is at least one fatty acid ester of a polyhydric alcohol wherein the fatty acid has at least 10 carbon atoms and may be a saturated or unsaturated fatty acid, and wherein the polyhydric alcohol is a polymeric polyol selected from polyalkylene glycols, polyglycerols, polymerized pentaerythritols or hexitols and the like. Specific examples of polyalkylene glycols that may be used to make fatty acid esters include, but are not limited to polyethylene glycol, polypropylene glycol, polybutylene glycol, and the like.

In a non-limiting embodiment, the polyalkylene glycol is polyethylene glycol.

In another non-limiting embodiment, the at least one binder material is at least one fatty alcohol ester of a carboxylic acid, wherein said fatty alcohol has at least 12 carbon atoms, and may be a saturated or unsaturated fatty alcohol and wherein the carboxylic acid has at least 2 carbon atoms, and has straight, branched, or cyclic groups and the straight, branched, or cyclic groups may be saturated or unsaturated.

Fatty alcohols that may be used to make fatty alcohol esters include but are not limited to, lauryl alcohol (dodecanol, 1-dodecanol), tridecyl alcohol (1-tridecanol, tridecanol, isotridecanol), myristyl alcohol (1-tetradecanol), pentadecyl alcohol (1-pentadecanol, pentadecanol), cetyl alcohol (1-hexadecanol), palmitoleyl alcohol (cis-9-hexadecen-1-ol), heptadecyl alcohol (1-n-heptadecanol, heptadecanol), stearyl alcohol (1-octadecanol), nonadecyl alcohol (1-nonadecanol), arachidyl alcohol (1-eicosanol), heneicosyl alcohol (1-heneicosanol), behenyl alcohol (1-docosanol), erucyl alcohol (cis-13-docosen-1-ol), lignoceryl alcohol (1-tetracosanol), ceryl alcohol (1-hexacosanol), 1-heptacosanol, montanyl alcohol, cluytyl alcohol, or 1-octacosanol, 1-nonacosanol, myricyl alcohol, melissyl alcohol, or 1-triacontanol, 1-dotriacontanol (lacceryl alcohol) and geddyl alcohol (1-tetratriacontanol). In a non-limiting embodiment, the fatty alcohol is stearyl alcohol.

Examples of carboxylic acids that may be used to make fatty alcohol esters include, but are not limited to, acetic acid (ethanoic acid), propionic acid (propanoic acid), butyric acid (butanoic acid), valeric acid (pentanoic acid), caproic acid (hexanoic acid), enanthic acid (heptanoic acid), caprylic acid (octanoic acid), pelargonic acid (nonanoic acid), capric acid (decanoic acid), undecylic acid (undecanoic acid), lauric acid (dodecanoic acid), tridecylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid) and arachidic acid (icosanoic acid).

Other examples of carboxylic acid that may be used include, but are not limited to, hydroxyl functional carboxylic acids such as glycolic acid, lactic acid, mandelic acid, 2 hydroxyisobutyric acid. 2-hydroxyhexanoic acid, and the like.

In a non-limiting embodiment, the at least one binder material is at least one animal fat. In another non-limiting embodiment, the at least one animal fat is selected from the group consisting of lard, beef tallow, poultry fat, including but not limited to chicken fat, duck fat, and goose fat, and mixtures thereof.

In a non-limiting embodiment, the at least one binder material is at least one wax. In another non-limiting embodiment, the at least one wax is selected from the group consisting of bayberry wax, beeswax, candelilla wax, carnauba wax, japan wax, montan wax, soy wax, castor wax, paraffin wax, petroleum wax, rice bran wax, safflower wax, stearic acid esters of erythritol wax, erythritol distearate wax, and mixtures thereof.

In another non-limiting embodiment, the at least one binder is a water soluble polymer which includes, but is not limited to, guar, guar derivatives, carboxymethyl guar, hydroxypropyl guar, carboxymethyl/hydroxypropyl guar, modified starch, starch derivatives, carboxymethyl starch, pregelatinized starch, alginates, pectins, polyacrylamides and derivatives thereof, polyethylene oxides, cellulose derivatives, carboxymethyl cellulose, hydroxyethyl cellulose, carboxymethylhydroxyethyl cellulose, methylhydroxyethyl cellulose, carboxymethyldihydroxypropyl cellulose, xanthan gum, wood-related products, and lignin.

In a non-limiting embodiment, the composition further comprises at least one liquid edible oil.

In a non-limiting embodiment, the at least one liquid edible oil is selected from the group consisting of liquid edible plant-derived oils and liquid edible animal-derived oils.

In a non-limiting embodiment, the at least one liquid edible oil is a liquid edible plant-derived oil. In another non-limiting embodiment, the liquid edible plant-derived oil is selected from the group consisting of almond oil, avocado oil, canola oil, castor oil, coconut oil, coriander oil, corn oil, cottonseed oil, grapeseed oil, flaxseed oil, hazelnut oil, hempseed oil, linseed oil, mango kernel oil, macadamia nut oil, olive oil, peanut oil, rapeseed oil, rice bran oil, safflower oil, sesame oil, soy oil, soybean oil, sunflower oil, walnut oil, and mixtures thereof. Other edible oils include oils selected from a group derived from nut oils such as beech nut oil, cashew oil, mongongo nut oil, pecan oil, pine nut oil, pistachio oil, walnut oil, pumpkin seed oil and a group derived from citrus oils such as grapefruit seed oil, lemon oil and orange oil. Edible oils may be selected from melon and gourd seeds such as watermelon seed oil, bitter gourd oil, bottle gourd oil, buffalo gourd oil, butternut squash seed oil, and pumpkin seed oil. Other edible oils may include acai oil, amaranth oil, apricot oil, apple seed oil, argan oil, avocado oil, babassu oil, ben oil, black seed oil, black currant seed oil, borage seed oil, borneo tallow nut oil, bape chestnut oil, barob pod oil (algaroba oil), cocoa butter, cocklebur oil, cohune oil, coriander seed oil, date seed oil, dika oil, evening primrose oil, false flax oil, flaxseed oil, grape seed oil, hemp oil, kapok seed oil, kenaf seed oil, Lallemantia oil, mafura oil, mafura butter, marula oil, meadowfoam seed oil, mustard oil (pressed), miger seed oil, nutmeg butter, okra seed oil, papaya seed oil, perilla seed oil, persimmon seed oil, pequi oil, pili nut oil, pomegranate seed oil, poppyseed oil, pracaxi oil, prune kernel oil, ramtil oil, rice bran oil, royle oil, shea nuts, sacha inchi oil, sapote oil, shea oil, shea butter, taramira oil, tea seed oil (camellia oil), thistle oil, tigernut oil, tobacco seed oil, tomato seed oil, wheat germ oil and mixtures thereof.

In a non-limiting embodiment, the at least one purifying material is present in the composition in an amount of from about 0.1 wt. % to about 99 wt. %. In another non-limiting embodiment, the at least one purifying material is present in the composition in an amount of from about 0.1 wt. % to about 90 wt. %.

In a non-limiting embodiment, the at least one binder material is present in said composition in an amount of from about 0.1 wt. % to about 99 wt. %. In another non-limiting embodiment, the at least one binder material is present in an amount of from about 0.1 wt. % to about 60 wt. %.

In a non-limiting embodiment, the at least one liquid edible oil, when present, is present in an amount of from about 0.1 wt. % to about 99 wt. %. In another non-limiting embodiment, the at least one liquid edible oil is present in an amount of from about 0.1 wt. % to about 60 wt.

In another non-limiting embodiment, the composition further comprises at least one additive that aids further in the purification of the liquid to be purified. Such additives include, but are not limited to, alkali materials and amino-functionalized materials such as functionalized silicas, such as those disclosed in published U.S. Patent Application No. 2019/0328011.

In another non-limiting embodiment, the compositions may further comprise at least one antioxidant for the purposes of maintaining oil stability in the formulations. Such additives can include synthetic antioxidants, natural antioxidants, and combinations thereof. Suitable synthetic antioxidants include, but are not limited to, butylated hydroxytoluene (BHT), butylated hydroxyanisole (BHA), propyl gallate (PG), pyrogallol (PY), tert-butyl hydroquinone, 2,5-ditert-butyl-hydroquinone (TBHQ), or α tocopherol and the like. Suitable natural antioxidants, include, but are not limited to, ascorbic acid or salts thereof, carnosol acid, carnosol, carotene, citric acid, lethicin, green tea extracts, sage extracts, sesamol, spearmint extracts, rosemary extracts, and the like.

In another non-limiting embodiment, the composition further comprises at least one antifoamer and where said antifoamer is a silicone such as dimethylpolysiloxane, or modified silicones such those described in U.S. Pat. No. 6,417,528, the contents of which are incorporated herein by reference.

In general, the compositions of the present invention are prepared by heating the at least one purifying material. The at least one binder material and, if desired, the at least one liquid edible oil is (are) heated separately until the at least one binder material has melted. After the at least one binder material has melted, the at least one binder material and the at least one liquid edible oil, if present, is (are) added to the at least one purifying material and mixed until a free flowing powder is obtained. The resulting free flowing powder then is passed through one or more sieves in order to obtain a powder that is substantially dust-free.

The powder then is placed into a die that may have any of a variety of shapes, including but not limited to, cylindrical, triangular, rectangular, square, trapezoidal, pentagonal, hexagonal, heptagonal, octagonal, spherical, and the like. A hydraulic press then is assembled, and the powder in the die is compressed with the hydraulic press at a desired pressure and held at that pressure (such as, for example, from about 0.01 to about 10 metric tons) for a specific amount of time (such as, for example, from about 5 seconds to about 5 minutes) or until there is no drop in pressure. The resulting product is a solid composition of a tablet-like shape that substantially is dust-free.

In a non-limiting embodiment, magnesium silicate powder is placed in a beaker and heated to between 50° C. (122° F.) and 165° C. (320° F.) for 5 to 45 minutes. Hydrogenated soybean oil, or candelilla wax, or palm oil, or mixtures thereof, and a liquid edible plant-derived oil are heated to between 70° C. (158° F.) and 100° C. (212° F.) until all oils and/or wax are melted. The melted oil(s) and/or wax and the liquid edible plant-derived oil are added to the magnesium silicate powder until a free flowing powder is obtained. The mixing is continued for an additional 15 minutes. The resulting powder formulation then is passed through a 500 μm sieve and then a 425 μm sieve to provide a powder that substantially is dust-free.

The powder then is weighed and placed into a cylindrical die. The powder in the die is compressed with a hydraulic press to a desired pressure and held at that pressure for a specific amount of time or until there is no drop in pressure, thereby providing a solid adsorbent composition of a tablet-like shape that substantially is dust-free.

The resulting “tablet” may have a variety of shapes, such as, for example, cylindrical (such as a form similar to a hockey puck, for example), spherical, cubic, pyramidal, rectangular prism, trapezoidal prism, other polygonal prisms, such as pentagonal, hexagonal, heptagonal, and octagonal prisms, hollow forms (such as a donut shape), and the like. It is to be understood, however, that the scope of the present invention is not to be limited to any particular method of making the compositions of the present invention, nor to any particular shape of the compositions of the present invention.

The “tablet-like” compositions of the present invention may be used to purify a variety of liquids, including, but not limited to, used cooking oil, unrefined edible oils, biodiesel fuel, and dielectric fluids, including but not limited to, petroleum-based and vegetable-based dielectric fluids. In general, the “tablet” is placed in the liquid to be purified, the liquid is heated, and the “tablet” disintegrates, whereby the at least one adsorbent material is released into the liquid, whereby the liquid is purified.

In a non-limiting embodiment, the “tablet” is placed in hot used cooking oil which has been heated to a temperature of from about 93° C. (200° F.) to about 204° C. (400° F.). Within 10 seconds to 10 minutes, the solid “tablet” disintegrates, thereby releasing the at least one adsorbent material, such as magnesium silicate powder, for example, into the used cooking oil. The at least one adsorbent material, such as magnesium silicate powder, then removes impurities such as free fatty acids, from the used cooking oil.

Thus, in accordance with another aspect of the present invention, there is provided a method of purifying a liquid. The method comprises contacting the liquid with a composition comprising at least one purifying material and at least one binder material. The at least one binder material is selected from the group consisting of hydrogenated vegetable oils, saturated vegetable oils, animal fats, waxes, water, glycols, and mixtures thereof. The liquid then is heated to effect disintegration of the composition, whereby the at least one purifying material is released from the composition and contacts the liquid, thereby purifying the liquid.

In a non-limiting embodiment, the at least one purifying material is selected from those hereinabove described.

In another non-limiting embodiment, the at least one binder material is a hydrogenated vegetable oil, which may be soybean oil, as hereinabove described.

In another non-limiting embodiment, the at least one binder material is a saturated vegetable oil, which may be palm oil or peanut oil, as hereinabove described.

In another non-limiting embodiment, the at least one binder material is at least one animal fat, which may be selected from those hereinabove described.

In another non-limiting embodiment, the at least one binder material is at least one wax, which may be selected from those hereinabove described.

In another non-limiting embodiment, the composition further comprises at least one liquid edible oil. In another non-limiting embodiment, the at least one liquid edible oil is selected from the group consisting of liquid edible plant-derived oils and liquid edible animal-derived oils.

In another non-limiting embodiment, the at least one liquid edible oils is at least one liquid edible plant-derived oil, which may be selected form those hereinabove described.

In non-limiting embodiments, the at least one adsorbent material, the at least one binder material, and the at least one edible oil, when present, are present in the composition in the amounts hereinabove described.

The liquid to be purified is heated to a temperature sufficient to effect disintegration of the composition, whereby the at least one adsorbent material is released into the liquid to be purified, thereby purifying the liquid. In a non-limiting embodiment, the liquid is heated to a temperature of from about 32° F. to about 500° F. In another non-limiting embodiment, the liquid is heated to a temperature of from about 100° F. to about 425° F. In yet another non-limiting embodiment, the liquid is heated to a temperature of from about 2° F. to about 400° F.

The liquid to be purified may be selected from those hereinabove described. In a non-limiting embodiment, the liquid to be purified is used cooking oil. In another non-limiting embodiment, the liquid to be purified is an unrefined edible oil. In yet another non-limiting embodiment, the liquid to be purified is biodiesel fuel. In another non-limiting embodiment, the liquid to be purified is a dielectric fluid.

Alternatively, in accordance with yet another aspect of the present invention, there is provided a composition for purifying a liquid that comprises at least one purifying material and at least one frozen liquid.

In a non-limiting embodiment, the at least one purifying material is selected from those hereinabove described. In another non-limiting embodiment, the at least one purifying material comprises magnesium silicate. The magnesium silicate may be selected from those hereinabove described.

In another non-limiting embodiment, the at least one frozen liquid is frozen water, or ice.

In another non-limiting embodiment, the composition may further comprise at least one binder material, such as those hereinabove described, and/or at least one liquid edible oil, such as those hereinabove described.

In a non-limiting embodiment, the at least one purifying material is present in the composition in an amount of from about 0.1 wt. % to about 99 wt. %, based on the total weight of the composition. In another non-limiting embodiment, the at least one purifying material is present in an amount of from about 0.1 wt. % to about 90 wt. %.

In a non-limiting embodiment, the at least one frozen liquid is present in the composition in an amount of from about 0.1 wt. % to about 99 wt. %, based on the total weight of the composition. In another non-limiting embodiment, the at least one frozen liquid is present in an amount of from about 0.1 wt. % to about 90 wt. %.

In a non-limiting embodiment, the at least one binder material, when present, is present in the composition in an amount of from about 0.1 wt. % to about 99 wt. %, based on the total weight of the composition. In another non-limiting embodiment, the at least one binder material is present in an amount of from about 0.1 wt. % to about 60 wt. %.

In a non-limiting embodiment, the at least one liquid edible oil, when present, is present in the composition in an amount of from about 0.1 wt. % to about 99 wt. %, based on the total weight of the composition. In another non-limiting embodiment, the at least one liquid edible oil is present in an amount of from about 0.1 wt. % to about 60 wt. %.

Such compositions may be prepared by admixing the at least one purifying material with at least one liquid material, and, if desired, the at least one binder material, and/or the at least one liquid edible oil. The resulting mixture then is cooled to a temperature which is at or below the freezing point of the liquid, such as, for example, from about −50° C. to about 0° C., thereby providing a solid composition comprising at least one purifying material and a frozen liquid. The composition then is maintained at a temperature that is at or below the freezing temperature of the liquid until the composition is needed for purifying a liquid as hereinabove described, such as, for example, used cooking oil, unrefined edible oil, biodiesel fuel, or a dielectric fluid. Upon contact of the composition with the liquid to be purified, the frozen liquid is heated by the liquid to be purified, whereby the frozen liquid is melted, and the at least one purifying is released into the liquid, such as, for example, used cooking oil, that is to be purified.

In a non-limiting embodiment, at least one purifying material, such as, for example, magnesium silicate powder, is mixed with water to form a mixture of magnesium silicate and water. The resulting mixture then is cooled to a temperature that is at or below the freezing point of water, i.e., 0° C. (32° F.). For example, the mixture may be cooled to −10° C. (14° F.), whereby there is provided a frozen composition of magnesium silicate powder and ice. The composition is kept frozen until it is needed to purify a liquid, such as hot used cooking oil, for example. The frozen composition then is placed into the hot used cooking oil, whereby the ice melts and the magnesium silicate powder is released into the hot used cooking oil, whereby the used cooking oil is purified.

In accordance with yet another aspect of the present invention, there is provided a method of purifying a liquid. The method comprises contacting the liquid with a composition comprising at least one purifying material and a frozen liquid. The liquid is maintained at a temperature effective to effect melting of the frozen liquid, whereby the at least one purifying material is released from the composition and contacts the liquid to be purified, thereby purifying such liquid.

The at least one purifying material and at least one frozen liquid may be selected from those hereinabove described.

In another non-limiting embodiment, the composition may further comprise at least one binder material, such as those hereinabove described, and/or at least one liquid edible oil, such as those hereinabove described.

### BRIEF DESCRIPTION OF THE DRAWINGS

The invention now will be described with respect to the drawings, wherein:

FIG. 1 is a graph showing particle size distribution of magnesium silicate particles recovered from an adsorbent composition of the present invention used to purify frying oil, after washing the particles with hexane to remove residual frying oil; and

FIG. 2 is a graph showing particle size distribution of magnesium silicate not formed into an adsorbent composition of the present invention.

### EXAMPLES

The invention now will be described with respect to the following examples. It is to be understood, however, that the scope of the present invention is not intended to be limited thereby.

General procedures for the preparation of powder formulations and compressed solid articles are provided below followed by individual examples. The examples include determination of solid adsorbent disintegration times in oil into individual particles.

The following materials were used in the examples hereinbelow:

canola oil

candelilla wax

corn oil

soybean oil

hydrogenated soybean oil

palm oil

peanut oil

sodium silicate

magnesium silicate (Magnesol® powder, The Dallas Group of America Inc.)

Magnesol® powder is a magnesium silicate having a pH of from 8.5 to 8.8 in a 5% suspension in deionized water, a mean particle size of from 100 to 120 microns, a molar ratio of silicon dioxide to magnesium oxide of from 2.6 to 2.7, and a surface area of from 500 to 700 square meters per gram.

### General Procedure for Making Powder Formulations

The edible or frying oils were placed in a container and heated to 70° to 100° C. Hydrogenated soybean oil, wax, or palm oil was placed in another container and heated to 70 to 100° C. (or up to the melting point of the wax or oil). Synthetic magnesium silicate adsorbent powder was charged into a reactor and heated at 50° to 160° C. for 5 to 30 minutes. The oils and waxes were added to the hot powder with mixing. Mixing was continued until the mixture had cooled to room temperature, resulting in a free flowing powder formulation. The powder then was sieved through two sieve screens: No. 35 (500 microns) and No. 40 (425 microns).

### General Procedure for Compressing of Powder Formulation

Each powder formulation to be compressed was weighed into a stainless steel cylindrical pressing die. The die was assembled and placed onto a hydraulic press. The powder was compressed to a pre-determined pressure and held at this pressure until there was no drop in pressure. Pressure was released and the resulting solid adsorbent was released from the pressing die. For small solid adsorbent (2-4 grams) compositions, a 1″ (25 mm) diameter cylindrical pressing die was used. For large solid adsorbent compositions (50-300 grams) a 4″ (102 mm) diameter cylindrical pressing die was used.

### General Procedure for Puck Disintegration Testing

Oil was heated to the desired testing temperature. A puck for testing was placed in the hot oil and allowed to disintegrate fully into fine particles.

### Examples 1-6. Solid Adsorbent Formulations with Magnesium Silicate, Canola Oil and Hydrogenated Soybean Oil

Powder formulations and solid adsorbent formulations were made from magnesium silicate, canola oil, and hydrogenated soybean oil according to the general methods described above. Table 1 shows exemplary compositions and the performance of such solid adsorbent compositions. Disintegration tests of the resulting solid adsorbents were performed at 1185° C. (365° F.) in frying oil. The results are shown in Table 1 below.

TABLE 1

| | | | | Disintegration Time |
|---|---|---|---|---|
| | | | | (4 g of Solid |
| | | | | Adsorbent |
| | | | Hydrogenated | Compressed to 1.0 |
| | Magnesium | Canola | Soybean | metric Tons) |
| Example | Silicate, | Oil, | Oil, | (Frying oil at 185° C.) |
| No. | weight % | weight % | weight % | (seconds) |
| 1 | 50 | 50 | 0.0 | n.d* |
| 2 | 50 | 49.5 | 0.5 | n.d* |
| 3 | 50 | 49.0 | 1.0 | 35 |
| 4 | 50 | 47.0 | 3.0 | 17 |
| 5 | 50 | 45.0 | 5.0 | 22 |
| 6 | 50 | 40.0 | 10.0 | 16 |

n.d* = no disintegrations after 5 minutes.

### Examples 7-9. Solid Adsorbents with Magnesium Silicate, Peanut Oil and Candelilla Wax

Powder formulations and solid adsorbent formulations were made from magnesium silicate, peanut oil, and candelilla wax according to the general methods described above. Table 2 shows exemplary solid adsorbent compositions and the performance of such solid compositions compressed at 1.0 metric tons for 15 seconds using a 1″ (25 mm) diameter cylindrical pressing die. Disintegration tests of the resulting solid adsorbents were performed at 185° C. (365° F.) in frying oil. The results are shown in Table 2 below.

TABLE 2

| | | | | Disintegration Time |
|---|---|---|---|---|
| | | | | (4 g of Solid |
| | | | | Adsorbent |
| | | | | Compressed to 1.0 |
| | Magnesium | Peanut | Candelilla | metric Tons) |
| Example | Silicate, | Oil, | Wax, | (Frying oil at 185° C.) |
| No. | weight % | weight % | weight % | (seconds) |
| 7 | 50 | 49 | 1 | 123 |
| 8 | 50 | 47 | 3 | 40 |
| 9 | 50 | 45 | 5 | 19 |

### Examples 10-14. Solid Adsorbents with Magnesium Silicate, Soybean Oil and Hydrogenated Soybean Oil

Powder formulations and solid adsorbent formulations were made from magnesium silicate, soybean oil, and hydrogenated soybean oil according to the general methods described above with magnesium silicate having been heated to 90° C. and the oils to 80° C. About 270 grams of each powder formulations were compressed into solid adsorbent at 4.5 metric tons for about 2 minutes using a 4″ (76 mm) diameter cylindrical die press. Table 3 shows exemplary solid adsorbent compositions and the disintegration performance. Disintegration tests of the resulting solid adsorbents were performed at 176.7° C. (350° F.) in frying oil. The results are shown in Table 3 below.

TABLE 3

| | Magnesium | Soybean | Hydrogenated | Disintegration Time, |
|---|---|---|---|---|
| Example | Silicate, | Oil, | Soybean Oil, | Oil at 350□□ F. |
| No. | weight % | weight % | weight % | (seconds) |
| 10 | 50 | 50 | 0 | nd |
| 11 | 50 | 47 | 3 | 217 |
| 12 | 50 | 45 | 5 | 174 |
| 13 | 50 | 43 | 7 | 195 |
| 14 | 50 | 41 | 9 | 198 |

nd = no disintegration

A portion of the filter cake formed as a result of treating frying oil at 350° F. (176.7° C.) with the solid adsorbent of Example 12 compressed to 4.5 metric tons was collected after the oil was filtered. About 50 grams of the filter cake were collected and placed in a beaker, after which 100 grams of hexane were added. The hexane/filter cake mixture was stirred for about 5 minutes and filtered over a Whatman® filter paper No. 1 using a Buchner funnel attached to a filter flask in vacuo. The filter cake was washed further with two additional portions of 100 grams of hexane and dried in a 105° C. oven for 1 hour, thereby providing an off-white powder.

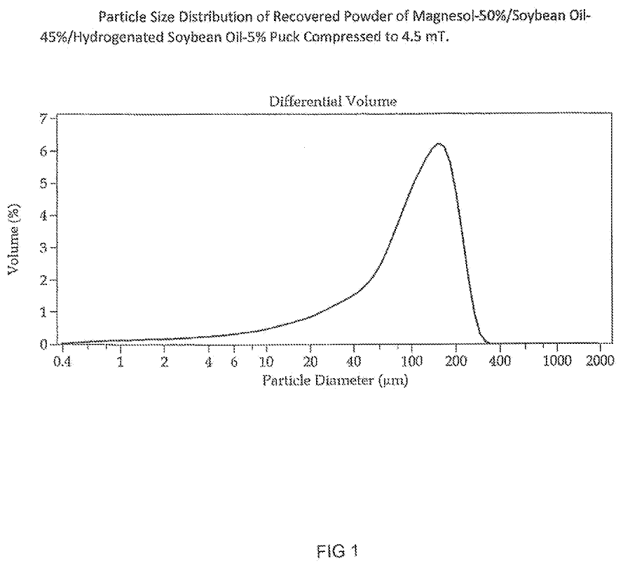

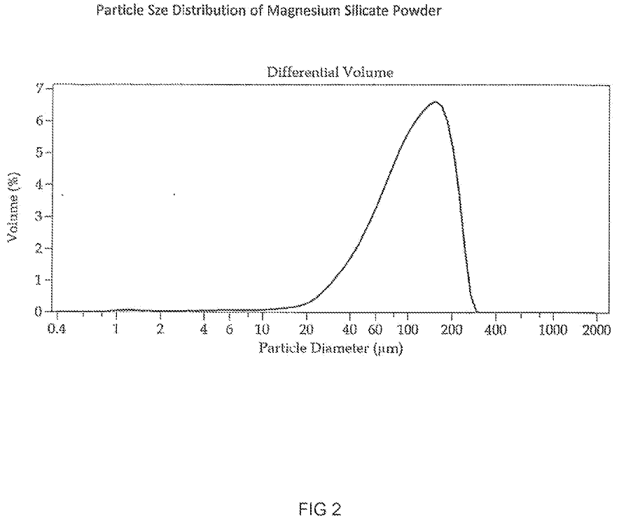

Particle size analysis was performed on the powder from the washings using a Laser Diffraction Particle Size Analyzer (Beckman Coulter LS 13 320). As shown in FIG. 1, the recovered magnesium silicate particles were found to be intact showing good particle size distribution which was not significantly different from particle size distribution of the original magnesium silicate powder shown in FIG. 2. These results show that the preparation of a solid composition of the present invention from magnesium silicate particles does not affect the integrity of the particles significantly.

### Examples 15-17. Solid Adsorbent Formulations Made with Magnesium Silicate, and Mixtures of Corn Oil, Soybean Oil and Hydrogenated Soybean Oil

Solid adsorbent formulations were made from magnesium silicate and varying amounts of corn oil, soybean oil and hydrogenated soybean oil according to general methods described above. The powder formulation was made into solid adsorbents using 4.0 grams of material compressed at 1.0 metric ton for 15 seconds. The resulting solid composition disintegrated into particles upon treatment with frying oil at 185° C. (365° F.) and the results are shown in Table 4.

TABLE 4

| | | | | Hydro- | Disinte- |
|---|---|---|---|---|---|
| | | | | genated | gration |
| | Magnesium | Corn | Soybean | Soybean | Time, Oil at |
| Example | Silicate, | Oil, | Oil, | Oil, | 365□ F. |
| No. | weight % | weight % | weight % | weight % | (seconds) |
| 15 | 50 | 25 | 25 | 0 | nd |
| 16 | 50 | 23.5 | 23.5 | 3 | 32 |
| 17 | 50 | 23 | 23 | 4 | 42 |

### Example 18. Solid Adsorbent Formulation with Magnesium Silicate, Canola Oil and Palm Oil

A powder formulation and corresponding solid adsorbent formulation were made from 50% magnesium silicate, 35% canola oil, and 15% palm oil by weight according to the general methods described above. In this instance, magnesium silicate was heated to 150° C., canola oil to 80° C., and palm oil to 110° C. prior to mixing into a free-flowing powder. The powder formulation was made into a solid adsorbent using 4.0 grams of material compressed at 1.0 metric ton for 15 seconds. The resulting solid composition disintegrated into particles in 53 seconds upon treatment with frying oil at 185° C. (365° F.).

### Example 19. Solid Adsorbent Formulation with Magnesium Silicate, Sodium Silicate, Canola Oil and Hydrogenated Soybean Oil

A powder formulation and corresponding solid adsorbent formulation were made from 50% magnesium silicate, 10% sodium silicate, 35% canola oil, and 5% hydrogenated soybean oil by weight according to the general methods described above. The powder formulation was made into a solid adsorbent using 4.0 grams of material compressed at 0.5 metric tons for 15 seconds. The resulting solid composition disintegrated into particles in 33 seconds upon treatment with frying oil at 185° C. (365° F.).

### Example 20. Solid Adsorbent Composition with Magnesium Silicate. Soybean Oil and Water

A powder formulation and corresponding solid adsorbent composition were made from magnesium silicate (50%) and soybean oil (40%) by mixing the silicate with oil at 90° C. and allowing the mixture to cool to room temperature. Water (10%) then was added to the powder mixture and mixed thoroughly. The powder formulation was made into a solid adsorbent using 4.0 grams of material compressed at 1.0 metric ton for 15 seconds. The resulting solid composition disintegrated into particles in 40 seconds upon treatment with frying oil at 185° C. (365° F.).

### Example 21. Frozen Solid Adsorbent Composition with Magnesium Silicate and Water

Water was used as a liquid to form a magnesium silicate concentrated slurry. 7 grams of magnesium silicate powder was mixed with 10 grams of water for a few minutes to provide 17 grams of a wet powder formulation with a water content of around 60%. The sample was placed in a plastic container (5 cm in diameter) to make a cylindrical solid shape. The container with the wet powder was frozen at a refrigerator temperature of −10° C. for 2 hours. The frozen formulation kept a cylindrical shape after being removed from the container and did not contain any cracks. This frozen solid was used in a disintegration test in which 200 g of frying oil was heated to 185° C. (365° F.). The resulting solid composition disintegrated into particles in 180 seconds upon contact with oil.

### Example 22 Solid Adsorbent Formulation with Magnesium Silicate, Soybean Oil and Stearic Acid

A powder formulation and corresponding solid adsorbent formulation were made from 50% magnesium silicate, 47% soybean oil and 3% stearic acid by weight according to the general methods described above. In this instance magnesium silicate was heated to 90° C., and soybean oil and stearic acid were heated to 80° C. prior to mixing into a free-flowing powder. The powder formulation was made into a solid adsorbent using about 270 grams of material compressed at 8.0 metric tons for 120 seconds. The resulting solid composition disintegrated into particles in 148 seconds upon contact with frying oil at 185° C. (365° F.).

### Examples 23, 24, 25, 26, and 27

Solid Adsorbent Compositions Made from Magnesium Silicate, Oils, and Fatty Binders (Stearyl Alcohol, Ethyl Stearate, Glyceryl Monostearate, Polyethylene Oxide Stearate or Sorbitan Monostearate)

Powder formulations and corresponding solid adsorbent formulations were made from magnesium silicate, frying oils and binders given in Table 5 below according to general methods described above. In this instance magnesium silicate was heated to 90° C., the oils and the binders (stearyl alcohol, ethyl stearate, glyceryl monostearate, polyethylene oxide stearate or sorbitan monostearate) were heated to 80° C. prior to mixing into a free-flowing powder. The powder formulations were made into solid adsorbents using about 4.0 grams of material compressed at 1.0 metric ton for 15 seconds. The resulting solid compositions disintegrated into particles upon treatment with hot frying oil at 176.7° C. (350° F.). The formulation compositions, in weight percent, and disintegration times are given in Table 5 below.

TABLE 5

| Materials | Example 23 | Example 24 | Example 25 | Example 26 | Example 27 |
|---|---|---|---|---|---|
| Magnesium Silicate Powder | 50.0 | 50.0 | 50.0 | 50.0 | 50.0 |
| Canola Oil | 12.5 | | | 25.0 | |
| Corn Oil | 12.5 | 25.0 | | | |
| Peanut Oil | | | | | 25.0 |
| Soybean Oil | | | 45.0 | | |
| Stearyl Alcohol | 25.0 | | | | |
| Ethyl Stearate | | 25.0 | | | |
| Glyceryl Monostearate | | | 5.0 | | |
| Polyethylene oxide Stearate | | | | 25.0 | |
| Sorbital Monostearate | | | | | 20.0 |

Solid Adsorbent Composition Performance

| | | | | | |
|---|---|---|---|---|---|
| Solid Adsorbent, grams | 4.0 | 4.0 | 4.0 | 4.0 | 4.0 |
| Compression Force, mT | 1.0 | 1.0 | 1.0 | 1.0 | 1.0 |
| Disintegration Time, Sec (350° F.) | 45 | 19 | 22 | 38 | 40 |

The disclosures of all patents and publications, including published patent applications, are incorporated herein by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A composition for purifying a liquid, comprising:
at least one purifying material; and
at least one binder material, wherein said at least one binder material is selected from the group consisting of hydrogenated vegetable oils, saturated vegetable oils, animal fats, waxes, water, glycols, fatty acids, fatty alcohols, fatty acid esters, fatty alcohol esters, and mixtures thereof.

2. The composition of claim 1 wherein said at least one purifying material is selected from the group consisting of metal silicates, silica gel, activated carbon, alkali metal silicates, magnesium phosphate, metal hydroxides, metal oxides, metal carbonates, metal bicarbonates, alkaline earth metal hydroxides, alkaline earth metal oxides, sodium sesquicarbonate, bleaching clays, bleaching earths, bentonite clay, diatomaceous earth, alumina, diatomite, and mixtures thereof.

3. The composition of claim 2 wherein said at least one purifying material comprises at least one metal silicate.

4. The composition of claim 3 wherein said at least one metal silicate is selected from the group consisting of magnesium silicate, magnesium aluminum silicate, calcium silicate, aluminum silicate, sodium silicate, and mixtures thereof.

5. The composition of claim 4 wherein said at least one metal silicate comprises magnesium silicate.

6. The composition of claim 1 wherein said at least one binder material is at least one hydrogenated vegetable oil.

7. The composition of claim 1 wherein said at least one binder material is at least one animal fat.

8. The composition of claim 1 wherein said at least one binder material is at least one wax.

9. The composition of claim 1 and further comprising at least one liquid edible oil.

10. The composition of claim 1 wherein said at least one purifying material is present in said composition in an amount of from about 0.1 wt. % to about 99 wt. %.

11. The composition of claim 10 wherein said at least one purifying material is present in said composition in an amount of from about 0.1 wt. % to about 90 wt. %.

12. The composition of claim 1 wherein said at least one binder material is present in said composition in an amount of from about 0.1 wt. % to about 99 wt. %.

13. The composition of claim 12 wherein said at least one binder material is present in said composition in an amount of from about 0.1 wt. % to about 60 wt. %.

14. The composition of claim 9 wherein said at least one liquid edible oil is present in said composition in an amount of from about 0.1 wt. % to about 99 wt. %.

15. The composition of claim 14 wherein said at least one liquid edible oil is present in said composition in an amount of from about 0.1 wt. % to about 60 wt. %.

16. A method of purifying a liquid comprising:
contacting said liquid with a composition comprising (i) at least one purifying material and (ii) at least one binder material, wherein said at least one binder material is selected from the group consisting of hydrogenated vegetable oils, saturated vegetable oils, animal fats, waxes, water, glycols, fatty acids and mixtures thereof, and
heating said liquid to a temperature effective to effect disintegration of said composition, whereby said at least one purifying material is released from said composition and contacts said liquid, thereby purifying said liquid.

17. The method of claim 16 wherein said at least one purifying material is selected from the group consisting of metal silicates, silica gel, activated carbon, alkali metal silicates, magnesium phosphate, metal hydroxides, metal oxides, metal carbonates, metal bicarbonates, alkaline earth metal hydroxides, alkaline earth metal oxides, sodium sesquicarbonate, bleaching clays, bleaching earths, bentonite clay, diatomaceous earth, alumina, diatomite, and mixtures thereof.

18. The method of claim 17 wherein said at least one purifying material comprises a metal silicate.

19. The method of claim 18 wherein said at least one metal silicate is selected from the group consisting of magnesium silicate, magnesium aluminum silicate, calcium silicate, aluminum silicate, and mixtures thereof.

20. The method of claim 19 wherein said at least one metal silicate comprises magnesium silicate.

21. The method of claim 16 wherein said at least one binder material is at least one hydrogenated vegetable oil.

22. The method of claim 16 wherein said at least one binder material is at least one animal fat.

23. The method of claim 16 wherein said at least one binder material is at least one wax.

24. The method of claim 16 wherein said composition further comprises at least one liquid edible oil.

25. The method of claim 16 wherein said at least one adsorbent material is present in said composition in an amount of from about 0.1 wt. % to about 99 wt. %.

26. The method of claim 25 wherein said at least one adsorbent material is present in said composition in an amount of from about 0.1 wt. % to about 90 wt. %.

27. The method of claim 16 wherein said at least one binder material is present in said composition in an amount of from about 0.1 wt. % to about 99 wt. %.

28. The method of claim 27 wherein said at least one binder material is present in said composition in an amount of from about 0.1 wt. % to about 60 wt. %.

29. The method of claim 24 wherein said at least one liquid edible oil is present in said composition in an amount of from about 0.1 wt. % to about 99 wt. %.

30. The method of claim 29 wherein said at least one liquid edible oil is present in said composition in an amount of from about 0.1 wt. % to about 60 wt. %.

31. The method of claim 16 wherein said liquid is heated to a temperature of from about 32° F. to about 500° F.

32. The method of claim 31 wherein said liquid is heated to a temperature of from about 100° F. to about 425° F.

33. The method of claim 32 wherein said liquid is heated to a temperature of from about 200° F. to about 400° F.

34. The method of claim 16 wherein said liquid is used cooking oil.

35. The method of claim 16 wherein said liquid is an unrefined edible oil.

36. The method of claim 16 wherein said liquid is biodiesel fuel.

37. The method of claim 16 wherein said liquid is a dielectric fluid.

38. A composition for purifying a liquid, comprising:
at least one purifying material; and
at least one frozen liquid.

39. The composition of claim 38 wherein said at least one purifying material is magnesium silicate.

40. The composition of claim 38 wherein said at least one frozen liquid is frozen water.

41. A method of purifying a liquid, comprising:
contacting said liquid with a composition comprising at least one purifying material and at least one frozen liquid, wherein said contacting is conducted at a temperature effective to effect melting of said at least one frozen liquid, whereby said at least one purifying material is released from said composition and contacts said liquid to be purified, thereby purifying said liquid to be purified.

42. The method of claim 41 wherein said at least one purifying material is magnesium silicate.

43. The method of claim 41 wherein said at least one frozen liquid is frozen water.

44. The composition of claim 1 wherein said at least one binder material is at least one fatty acid.

45. The composition of claim 1 wherein said at least one binder material is at least one fatty alcohol, wherein said fatty alcohol has at least 12 carbon atoms.

46. The composition of claim 1 wherein said at least one binder material is at least one fatty acid ester of a monohydroxy compound, wherein said fatty acid has at least 10 carbon atoms, wherein said monohydroxy compound has 1 to 20 carbon atoms.

47. The composition of claim 46 wherein said at least one fatty acid has at least 16 carbon atoms.

48. The composition of claim 46 wherein said monohydroxy compound is an alkyl alcohol, alkenyl alcohol, alkynyl alcohol, aralkyl alcohol, aryl alcohol or alkyether alcohol.

49. The composition of claim 1 wherein said at least one binder material is at least one fatty acid ester of a polyhydric alcohol wherein said fatty acid has at least 10 carbon atoms and wherein said polyhydric alcohol is a polyol having a linear, branched or cyclic unit which has at least 2 carbon atoms, and at least 2 hydroxyl groups per molecule.

50. The composition of claim 1 wherein said at least one binder material is at least one fatty acid ester of a polyhydric alcohol wherein said fatty acid has at least 10 carbon atoms, and wherein said polyhydric alcohol is a sugar alcohol.

51. The composition of claim 1 wherein said at least one binder material is at least one fatty acid ester of a polyhydric alcohol wherein said fatty acid has at least 10 carbon atoms, and wherein said polyhydric alcohol is selected from the group consisting polyalkylene glycols, polyglycerols, polymerized pentaerythritols and polymerized hexitols.

52. The composition of claim 1 wherein said at least one binder material is at least one fatty alcohol ester of a carboxylic acid, wherein said fatty alcohol has at least 12 carbon atoms, and wherein said carboxylic acid has at least 2 carbon atoms.

53. The composition of claim 52 wherein said fatty alcohol is selected from a group consisting of lauryl alcohol (dodecanol, 1-dodecanol), tridecyl alcohol (1-tridecanol, tridecanol, isotridecanol), myristyl alcohol (1-tetradecanol), pentadecyl alcohol (1-pentadecanol, pentadecanol), cetyl alcohol (1-hexadecanol), palmitoleyl alcohol (cis-9-hexadecen-1-ol), heptadecyl alcohol (1-n-heptadecanol, heptadecanol), stearyl alcohol (1-octadecanol), nonadecyl alcohol (1-nonadecanol), arachidyl alcohol (1-eicosanol), heneicosyl alcohol (1-heneicosanol), behenyl alcohol (1-docosanol), erucyl alcohol (cis-13-docosen-1-ol), lignoceryl alcohol (1-tetracosanol), ceryl alcohol (1-hexacosanol), 1-heptacosanol, montanyl alcohol, cluytyl alcohol, or 1-octacosanol, 1-nonacosanol, myricyl alcohol, melissyl alcohol, or 1-triacontanol, 1-dotriacontanol (lacceryl alcohol) and geddyl alcohol (1-tetratriacontanol).

54. The composition of claim 1 wherein said at least one purifying material is sodium hydroxide.

55. The composition of claim 4 wherein said at least one metal silicate is sodium silicate.
